(19) United States
(12) Patent Application Publication
(10) Pub. No.: US 2024/0034186 A1
(43) Pub. Date: Feb. 1, 2024

(54) BATTERY SWAPPING STATION

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Shanghai (CN); Chunhua Huang, Shanghai (CN)

(21) Appl. No.: 17/916,309

(22) PCT Filed: Apr. 6, 2021
(86) PCT No.: PCT/CN2021/085650

§ 371 Date: Sep. 14, 2023

(30) Foreign Application Priority Data
Apr. 3, 2020 (CN) 202010261303.4

(51) Int. Cl. B60L 53/80; B60L 53/30

(52) U.S. Cl. CPC B60L 53/80; B60L 53/30; B60S 5/06

(57) ABSTRACT

Disclosed is a battery swapping station, comprising a vehicle carrying platform, for parking an electric vehicle so as to swap battery packs; a charging device, which is provided with a plurality of charging bins for having battery packs placed therein, wherein electric connectors are arranged in the charging bins for being electrically connected to the battery packs located in the charging bins, so as to carry out charging; and a battery swapping device, for taking, placing and transferring batteries between the electric vehicle and the charging bin, the battery swapping device being provided with a overturning mechanism for vertically overturning a battery pack taken out from the charging bin or the electric vehicle. By means of the present invention, taking and placing of a large battery pack in a charging station within a small space and structure can be completed.

This application claims priority of Chinese patent application CN2020102613034, filed on Apr. 3, 2020. The contents of the above Chinese patent application are incorporated herein by reference in their entirety.

### FIELD OF INVENTION

The invention relates to a battery swapping station.

### PRIOR ARTS

At present, the field of battery swapping of electric vehicles is mainly divided into a chassis battery swapping and a side battery swapping, the side battery swapping is pulling out of the battery pack from the battery swapping vehicle through the battery swapping device, after the plane rotate 180° on the battery swapping device, the electric connection seat turns from facing the vehicle to facing the charging bin, and then insert the battery into the charging bin on the other side of the battery swapping device for charging. Due to the structural constraints of the vehicle itself, the existing method of two-side battery swapping is mostly adopted. To swap the battery on both sides, the battery pack needs to be rotated 180° on the device through the battery swapping device before charging into the charging bin.

However, due to the need to rotate the battery pack in a plane, the elongated battery pack needs a very large space when rotating, which will lead to a complex structure and a large volume of the battery swapping device, which not only directly affects the manufacturing difficulty of the battery swapping device, but also increases the area covered of the battery swapping station, so the electric vehicle can only use the form of multiple small battery packs to swap battery. However, the form of multiple battery packs requires higher cost for the battery packs of the vehicle, and there is a great contradiction in market acceptance, which is not conducive to mass production and promotion.

### CONTENT OF THE PRESENT INVENTION

The technical problem to be solved by the invention is to overcome the defects of the prior arts that the battery swapping station covers a large area, the structure of the battery swapping device is complex, and the cost of the battery is high, hence providing a battery swapping station.

The present invention solves the technical problem by the following technical solutions:

A battery swapping station, which is characterized in that, the battery swapping station comprises:
a vehicle carrying platform, for parking an electric vehicle so as to swap battery packs;
a charging device, which is provided with a plurality of charging bins for having battery packs placed therein, wherein electric connectors are arranged in the charging bins for being electrically connected to the battery packs located in the charging bins, so as to carry out charging;
and a battery swapping device, for taking, placing and transferring batteries between the electric vehicle and the charging bin, the battery swapping device being provided with an overturning mechanism for vertically overturning a battery pack taken out from the charging bin or the electric vehicle.

The overturning mechanism in the invention rotates the battery pack in the form of overturning. The overturning of the battery pack itself requires less space, and the overturning mechanism can be significantly reduced in structure relative to the battery swapping device that rotates in a plane. Therefore, the battery swapping device of the invention can complete taking and placing of a large battery pack in a charging station within a small space and structure. Therefore, battery swapping for an electric vehicle using a single large battery pack can be realized within a battery swapping station with a small occupied area, such that the cost of a battery pack is reduced, and popularization is facilitated.

Preferably, the overturning mechanism is used to overturn a discharged battery pack taken out from the electric vehicle from a first position to a second position in a first direction; the overturning mechanism is also used to overturn a fully charged battery pack taken out from the charging bin from a third position to a fourth position in a second direction, wherein the first direction is opposite to the second direction.

The first position and the fourth position can be the same position, and the second position and the third position can be the same position. Therefore, the overturning of the overturning mechanism is mainly carried out between the two positions.

Preferably, the overturning mechanism comprises a first overturning part and a second overturning part, the first overturning part is used to carry the battery pack at the first position or the fourth position, the second overturning part is used to carry the battery pack at the second position or the third position, and the first overturning part and the second overturning part are overturned coaxially.

Wherein, the first overturning part docks with the electric vehicle to complete the picking and placing of the battery pack, and the second overturning part docks with the charging bin to complete the picking and placing of the battery pack.

Preferably, the battery pack has a first side and a second side which are perpendicular to each other, when the battery pack is located at the first position or the fourth position, the first side is carried on the first overturning part, and the second side is abutted against the second overturning part; when the battery pack is located at the second position or the third position, the second side is carried on the second overturning part, and the first side is abutted against the first overturning part.

The first overturning part and the second overturning part cooperate with each other to limit and abut against the two sides of the battery pack. Therefore, when the battery pack is overturned, the shaking of the battery pack can be avoided and the stable overturning of the battery pack can be ensured.

Preferably, the first overturning part and the second overturning part are arranged vertically to each other.

Preferably, the first overturning part and the second overturning part are driven by the same overturning driving device, or the first overturning part and the second overturning part are driven by different overturning driving devices.

The first overturning part and the second overturning part, which are arranged vertically to each other, only need to overturn by 90 degrees to realize the rotation of the battery pack. Wherein, an electric connection seat of the battery pack at the first position and the fourth position is horizontally oriented to facilitate docking with the electric vehicle, and the battery pack at the second position and the third position is vertically oriented to facilitate docking with the charging device.

Preferably, the overturning driving device comprises a telescopic rod which is connected with the first overturning part and/or the second overturning part and drives the first overturning part and the second overturning part to rotate.

The telescopic rod generates the movement of the first overturning part and/or the second overturning part through its own length direction. The telescopic rod can be a pneumatic or hydraulic mechanism.

Preferably, the overturning driving device comprises an overturning motor and a gear set, the overturning motor drives the gear set to rotate, the gear set is connected with the first overturning part and/or the second overturning part and drives the first overturning part and/or the second overturning part to rotate.

The overturning motor can ensure that the first overturning part and/or the second overturning part overturn to the correct position by controlling its own amount of rotation.

Preferably, each of charging bins is further provided with a floating disc and a linkage mechanism, and the linkage mechanism is respectively connected with the floating disc and the electric connector, when the floating disc generates a first displacement in a first floating direction, the linkage mechanism drives the electric connector to move a second displacement in the direction close to the battery pack, so that the electric connector can be electrically connected with the battery pack.

The electric connector docks with the battery pack through linkage with the linkage mechanism, and is no longer a fixed electric connector, therefore, the moving electric connector does not need to have the same transmission direction as the battery pack, and the orientation of the electric connector can be any orientation. Wherein, the linkage mechanism generates linkage through the change of the carrying of the floating disc, so that the electric connector can respond in time and dock with the battery pack. The power for moving the electric connector comes from the gravity of the battery pack, and no external drive is required, which is beneficial to simplify the internal structure of the charging device.

Preferably, the first floating direction is a vertical downward direction, the floating disc carries the battery pack in a vertical direction, and the floating disc displaces toward the first floating direction with the gravity of the battery pack.

The first floating direction is vertical downward, that is, the gravity of the battery pack can be fully applied to the floating disc, so that the floating disc can drive the linkage mechanism more timely.

Preferably, an electric connection seat of the battery pack in the second position or the third position faces the electric connector in the charging bin.

Preferably, an electric connection seat of the battery pack in the first position or the fourth position faces the electric connector in the electric vehicle.

Preferably, the overturning mechanism is used to send the battery pack at the second position into the floating disc, and drive the electric connector to connect with the battery pack through the linkage mechanism; the overturning mechanism moves the battery pack out of the floating disc from the third position, and drives the electric connector to separate from the battery pack through the linkage mechanism.

Preferably, the linkage mechanism comprises a sliding mechanism, a first traction member and a second traction member, the first traction member is connected with the sliding mechanism and the floating disc respectively, the second traction member is connected with the electric connector and the mounting seat respectively, the electric connector is installed on the mounting seat and moves relative to the mounting seat, and the second traction member is slidably connected with the sliding mechanism.

This constitutes the structure of a movable pulley. Wherein, the moving distance of the second traction member is twice that of the first traction member, thereby realizing that the second displacement is greater than the first displacement.

Preferably, the overturning mechanism comprises a first overturning part and a second overturning part, the first overturning part is used to carry the battery pack in the first position taken out of the electric vehicle or to send the battery pack in the fourth position to the electric vehicle, the second overturning part is used to send the battery pack in the second position to the floating disc, or to carry the battery pack in the third position taken out from the floating disc.

Preferably, the battery swapping device comprises a lifting mechanism and an external frame, the overturning driving device is connected to the lifting mechanism and drives the overturning mechanism to rotatably connect relative to the lifting mechanism, the lifting mechanism is connected to the external frame and moves up and down relative to the external frame so as to dock with the charging bins of different heights.

Through the lifting mechanism, the position of the battery pack in the height direction can be adjusted, so that it can correspond to the charging bins of different heights.

Preferably, the first overturning part comprises a first extension mechanism, and the second overturning part comprises a second extension mechanism, wherein the first extension mechanism docks with the electric vehicle at the first position or the fourth position and takes and places the battery pack, and the second extension mechanism docks with the charging bin at the second position or the third position and takes and places the battery pack.

Wherein, the first extension mechanism docks with the electric vehicle to realize the taking and placing of the battery pack. The second extension mechanism docks with the charging bin to realize the taking and placing of the battery pack.

Preferably, a transmission route of the first extension mechanism and a transmission route of the second extension mechanism intersect, so that the battery pack is relayed between the first extension mechanism and the second extension mechanism.

After overturning, the second extension mechanism carries the battery pack for transportation. On the contrary, the battery pack naturally contacts the first extension mechanism after being transported to the end of the second extension mechanism. After overturning, the first extension mechanism carries the battery pack for transportation.

Preferably, the first overturning part and the second overturning part are both connected to a turnplate, the turnplate drives the first overturning part and the second overturning part to rotate together, wherein the second position and the third position are the same position, and the first position and the fourth position are the same position.

Preferably, at the first position and the fourth position, the first overturning part is horizontally arranged and docks with the electric vehicle; at the second position and the third position, the second overturning part is horizontally arranged and docks with the charging bin.

Preferably, the overturning mechanism comprises a first overturning part and a second overturning part, the first floating direction is a vertical downward direction, the second overturning part moves the battery pack into the floating disk in a horizontal position, the battery pack carries and receives the battery pack in a vertical direction, and the floating disk moves toward the first floating direction with the gravity of the battery pack.

Preferably, the electric connector is connected with a charging reset element, and after the battery pack is moved out from the floating disc by the overturning mechanism, the charging reset element drives the electric connector to reset.

Preferably, the battery swapping station has a battery swapping lane for the moving of the electric vehicle, one side or both sides of the battery swapping lane are provided with a charging device, and the battery swapping device performs reciprocating motion between the charging device and the electric vehicle.

The positive improved effects of this invention lie in: the battery swapping device of the battery swapping station of the invention can be significantly reduced in structure relative to the battery swapping device that rotates in a plane. By means of the present invention, taking and placing of a large battery pack in a charging station within a small space and structure can be completed. The charging device may match with battery packs with different orientations. Therefore, battery swapping for an electric vehicle using a single large battery pack can be realized within a battery swapping station with a small occupied area, such that the cost of a battery pack is reduced, and popularization is facilitated.

### BRIEF DESCRIPTION OF THE DRAWINGS

FIG. 1 is a schematic view of the battery swapping station in the embodiment 1 of the present invention.

FIG. 2 is a schematic view of the overall structure of the battery swapping device in the embodiment 1 of the present invention.

FIG. 3 is a schematic view of the overall structure of the overturning mechanism in the embodiment 1 of the present invention.

FIG. 4 is a schematic view of the overturning mechanism overturning 90 degrees in the embodiment 1 of the present invention.

FIG. 5 is a schematic view of the bottom structure of the overturning mechanism in the embodiment 1 of the present invention.

FIG. 6 is a schematic view of the top structure of the overturning mechanism in the embodiment 1 of the present invention.

FIG. 7 is a schematic view of the extension state of the extension mechanism in the embodiment 1 of the present invention.

FIG. 8 is a schematic view of taking out the battery pack by the overturning mechanism in the embodiment 1 of the present invention.

FIG. 9 is a schematic view of receiving the battery pack by the overturning mechanism in the embodiment 1 of the present invention.

FIG. 10 is a schematic view of the overall structure of the overturning mechanism in the embodiment 2 of the present invention.

FIG. 11 is a schematic view of the bottom structure of the overturning mechanism in the embodiment 2 of the present invention.

FIG. 12 is a schematic view of the structure of the charging assembly in the embodiment 1 of the present invention.

FIG. 13 is a schematic view of the arrangement and setting of the charging device in the embodiment 1 of the present invention.

FIG. 14 is a schematic view of the overall structure of the charging device in the embodiment 1 of the present invention.

FIG. 15 is a schematic view of the upper structure of the charging device in the embodiment 1 of the present invention.

FIG. 16 is a schematic view of the side structure of the charging device in the embodiment 1 of the present invention.

FIG. 17 is a schematic view of the bottom structure of the electric connector in the embodiment 1 of the present invention.

FIG. 18 is a schematic view of the structure of the battery swapping station in the embodiment 1 of the present invention.

### DETAILED DESCRIPTION OF THE PREFERRED EMBODIMENT

The following embodiments further illustrate the present invention, but the present invention is not limited by the following embodiments thereto.

### Embodiment 1

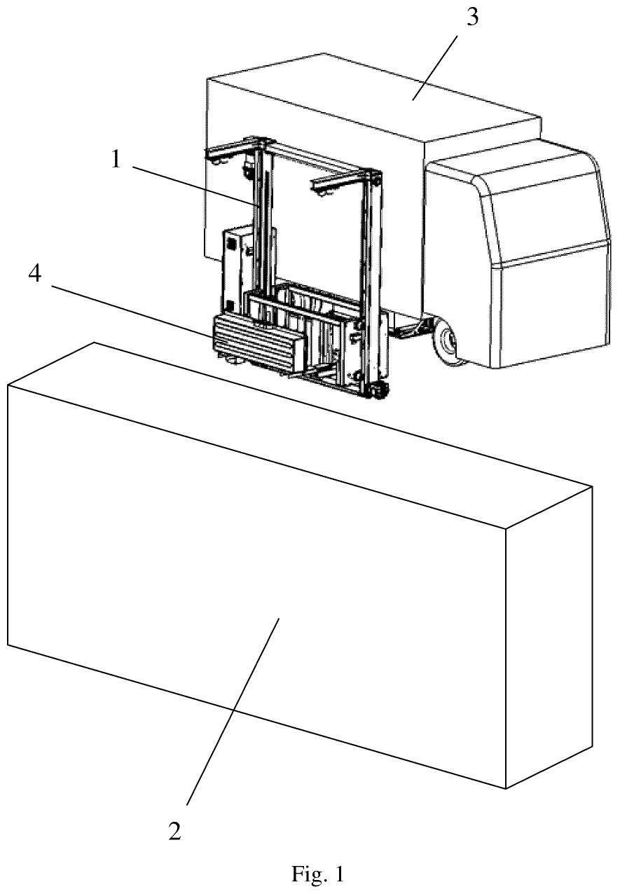

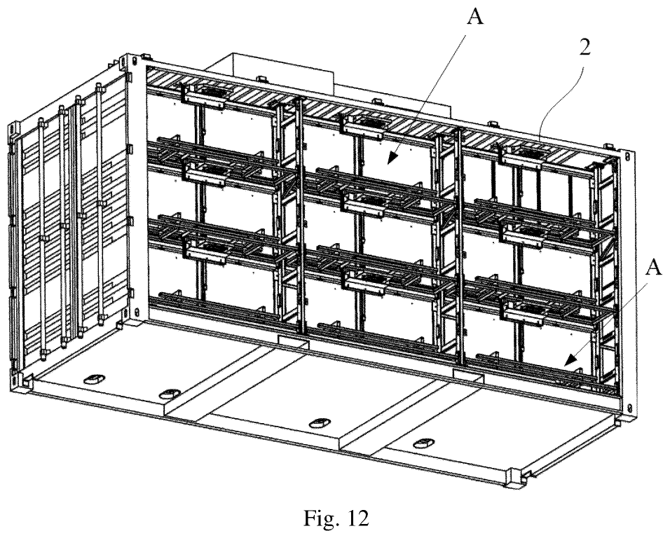

As shown in FIG. 1-FIG. 9, FIG. 12-FIG. 18, the embodiment discloses a battery swapping station, wherein the battery swapping station comprises a vehicle carrying platform, for parking an electric vehicle 3 so as to swap battery packs 4; a charging device 2, which is provided with a plurality of charging bins A for having battery packs 4 placed therein, wherein electric connectors 22 are arranged in the charging bins A for being electrically connected to the battery packs 4 located in the charging bins A, so as to carry out charging; and a battery swapping device 2, for taking, placing and transferring batteries between the electric vehicle 3 and the charging bin A, the battery swapping device 2 being provided with a overturning mechanism 10 for vertically overturning a battery pack 4 taken out from the charging bin A or the electric vehicle 3.

In the embodiment, The battery pack 4 is installed on the electric vehicle 3 to provide power, and the charging bin is arranged in the battery swapping station to provide charging and discharging services for the battery pack, when the battery pack on the vehicle is insufficient to provide power for the electric vehicle to continue driving, it is necessary to replace the battery in the battery swapping station in time, the battery swapping device in this solution is used for the side battery swapping of the electric vehicle, the battery swapping device is located in the battery swapping station, which has both the function of taking and placing the battery and the function of transferring the battery, that is to say, the battery swapping device can take and place the battery from the electric vehicle and the charging bin, and can also transfer the battery between the electric vehicle and charging bin, transfer a discharged battery pack from the electric vehicle to the charging bin, and transfer a fully charged battery from the charging bin to the electric vehicle, in other embodiments, the battery swapping device may only have the function of battery transfer, and the action of picking and placing the battery from the electric vehicle and the charging bin is performed by a separate battery taking-and-placing mechanism.

Using the overturning mechanism 10 in this solution, the battery pack 4 is overturned during the process of transferring the battery pack between the electric vehicle 3 and the charging bin, so as to adapt to the different orientations of the electric connectors in the electric vehicle and the charging bin.

Due to the different positions of the electric connectors in the electric vehicle 3 and the charging bin A, the battery swapping device 1 usually needs to rotate the battery pack 180 degrees to adapt to the position of the electric connector in the electric vehicle 3 or charging bin A, which is applicable to the battery swapping of the electric vehicles which have small size and multi-compartment batteries, resulting in that the battery swapping device needs large space to adapt to the rotation angle of the battery pack, in this solution, the battery pack is overturned vertically by the overturning mechanism of the battery swapping device to adapt to the position of the electric connector in the electric vehicle or the charging bin, which saves the space required for the battery pack to rotate, and at the same time, it can be used for the replacement of large-sized batteries, as well as the battery replacement of electric vehicles with single-compartment batteries, which improves the applicability of the battery swapping device.

The overturning mechanism 10 in the invention rotates the battery pack 4 in the form of overturning. The overturning of the battery pack 4 itself requires less space, and the overturning mechanism 10 can be significantly reduced in structure relative to the battery swapping device 2 that rotates in a plane. Therefore, the battery swapping device 2 of the invention can complete taking and placing of a large battery pack 4 in a charging station within a small space and structure. Therefore, battery swapping for an electric vehicle 3 using a single large battery pack 4 can be realized within a battery swapping station with a small occupied area, such that the cost of the battery pack is reduced, and popularization is facilitated.

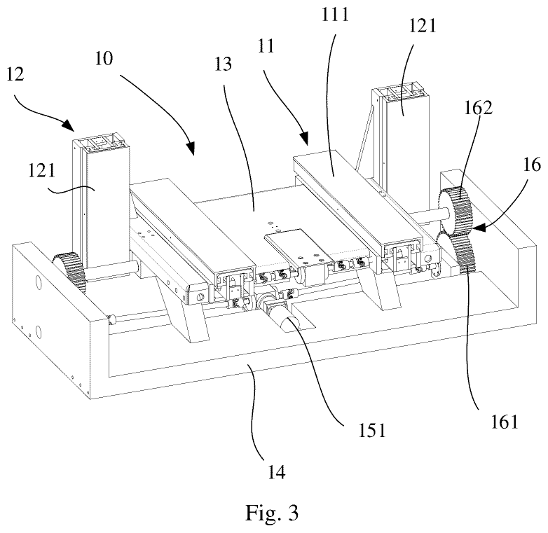

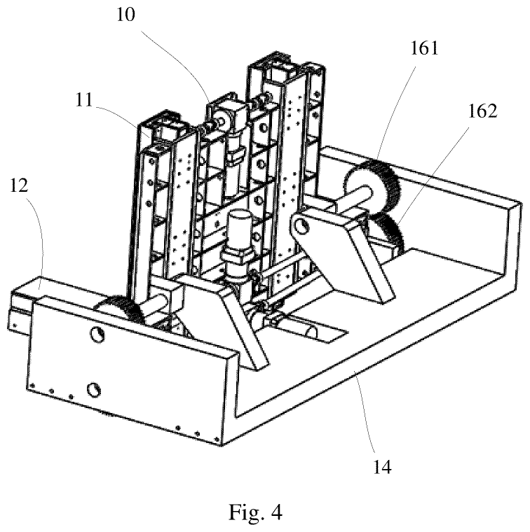

As shown in FIG. 3 and FIG. 4, the overturning mechanism 10 in the embodiment is used to overturn a discharged battery pack 4 taken out from the electric vehicle 3 from a first position to a second position in a first direction; the overturning mechanism 10 is also used to overturn a fully charged battery pack 4 taken out from the charging bins A from a third position to a fourth position in a second direction, wherein the first direction is opposite to the second direction. Preferably, the first position and the fourth position can be the same position, and the second position and the third position can be the same position. Therefore, the overturning of the overturning mechanism is mainly carried out between the two positions.

In the embodiment, the first position is the initial position of the discharged battery pack 4 taken out of the electric vehicle on the overturning mechanism 10, the second position is the position of the discharged battery pack 4 on the overturning mechanism 10 after overturning in the first direction, the third position is the initial position of the fully charged battery pack 4 taken out of the charging bin on the overturning mechanism 10, and the fourth position is the position of the fully charged battery pack 4 on the overturning mechanism 10 after overturning in the second direction, wherein the discharged battery pack 4 does not refer to the battery pack 4 with 0 power, but includes the case where the remaining power of the battery pack 4 is insufficient to power the electric vehicle to continue driving, the fully charged battery pack 4 is not the battery pack 4 with 100% power, but includes the case where the power of the battery pack 4 is sufficient to power the electric vehicle to continue driving.

As shown in FIG. 3 and FIG. 4, the overturning mechanism 10 in the embodiment comprises a first overturning part 11 and a second overturning part 12, the first overturning part 11 is used to carry the battery pack 4 at the first position or the fourth position, the second overturning part 12 is used to carry the battery pack 4 at the second position or the third position, and the first overturning part 11 and the second overturning part 12 are overturned coaxially. Wherein, the first overturning part 11 docks with the electric vehicle 3 when facing the first position and the fourth position to realize the taking and placing of the battery pack 4, and the second overturning part 12 docks with the charging bin A when facing the second position and the third position to realize the taking and placing of the battery pack 4. In the embodiment, the first overturning part and the second overturning part share a rotation shaft for overturning, so as to realize the synchronization of the first overturning part and the second overturning part, in other embodiments, the first overturning part and the second overturning part are respectively connected with different rotation shafts, so that the overturning of the first overturning part and the second overturning part can be controlled respectively.

As shown in FIG. 3, FIG. 4 and FIG. 9, the battery pack 4 in the embodiment has a first side and a second side which are perpendicular to each other, when the battery pack 4 is located at the first position or the fourth position, the first side is carried on the first overturning part 11, and the second side is abutted against the second overturning part 12; when the battery pack 4 is located at the second position or the third position, the second side is carried on the second overturning part 12, and the first side is abutted against the first overturning part 11. The first overturning part 11 and the second overturning part 12 cooperate with each other to limit and abut against the two sides of the battery pack 4. Therefore, when the battery pack 4 is overturned, the shaking of the battery pack 4 can be avoided and the stable overturning of the battery pack 4 can be ensured.

As shown in FIG. 3 and FIG. 4, in the embodiment, the first overturning part 11 and the second overturning part 12 are arranged vertically to each other. The first overturning part 11 and the second overturning part 12, which are arranged vertically to each other, only need to overturn by 90 degrees to realize the rotation of the battery pack 4. Wherein, an electric connection seat of the battery pack 4 at the first position and the fourth position is horizontally oriented to facilitate docking with the electric connector of the electric vehicle 3, and the battery pack 4 at the second position and the third position is vertically oriented to facilitate docking with the charging device 2 in the charging bin A. Preferably, the first overturning part 11 and the second overturning part 12 are driven by the same overturning driving device, or the first overturning part 11 and the second overturning part 12 are driven by different overturning driving devices. The first overturning part 11 and the second overturning part 12, which are arranged vertically to each other, only need to overturn by 90 degrees to realize the rotation of the battery pack. The motion of the first overturning part 11 and the second overturning part 12 can be driven simultaneously by the same overturning driving device, and the motion of the first overturning part 11 and the second overturning part 12 can be controlled respectively by different overturning driving devices. Wherein, the electric connection seat of the battery pack 4 at the first position and the fourth position is horizontally oriented to facilitate docking with the electric vehicle 3, and the battery pack 4 at the second position and the third position is vertically oriented to facilitate docking with the charging device 2.

In the embodiment, the first overturning part 11 and the second overturning part 12 are driven by the same overturning driving device, or the first overturning part 11 and the second overturning part 12 are driven by different overturning driving devices.

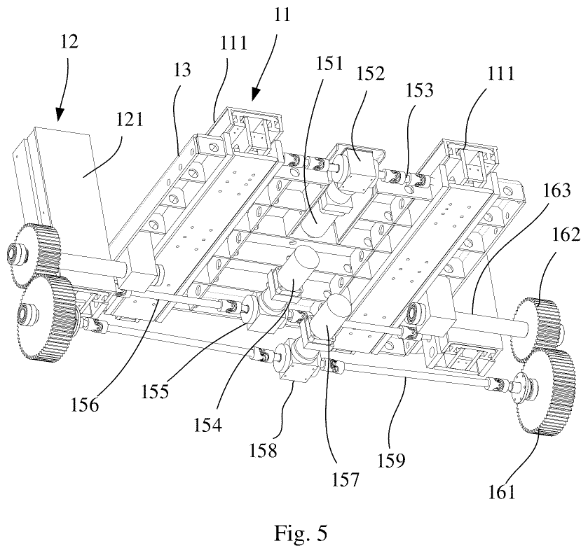

As shown in FIG. 3 and FIG. 5, the overturning driving device in the embodiment comprises an overturning motor 157 and a gear set 16, the overturning motor 157 drives the gear set 16 to rotate, the gear set 16 is connected with the first overturning part 11 and/or the second overturning part 12 and drives the first overturning part 11 and/or the second overturning part 12 to rotate. The overturning motor 157 can ensure that the first overturning part 11 and/or the second overturning part 12 turn to the correct position by controlling its own amount of rotation. The overturning motor 157 drives the gear set 16 to rotate by turning itself, so that the first overturning part 11 and/or the second overturning part 12 rotate together. Wherein, the overturning motor 157 connects a transmission shaft 159 through a reverser 158, so as to drive the gear set 16 to rotate.

As shown in FIG. 3 and FIG. 5, the overturning driving device in the embodiment comprises a overturning motor 157 and a gear set 16, wherein, the gear set 16 at least comprises an input gear 161 and an output gear 162, the input gear 161 and the output gear 162 are geared with each other, wherein, the overturning motor 157 directly or indirectly drives the input gear 161 to rotate, the first overturning part 11 and the second overturning part 12 are fixedly connected to the output gear 162 through an overturning shaft, and rotate with the output gear 162. The input gear 161 and the output gear 162 may be directly output or transmitted by other gears. The input gear 161 and the output gear 162 are driven by gear transmission, which can play the role of a speed reduction mechanism and increase the output torque at the same time, so that the first overturning part 11 and the second overturning part 12 can be driven.

As shown in FIG. 3 and FIG. 5, the first overturning part 11 in the embodiment comprises a first extension mechanism 111 and a turnplate 13, and the second overturning part 12 includes a second extension mechanism 121 and a turnplate 13. Wherein, the turnplate 13 in the embodiment is a part shared by the first overturning part 11 and the second overturning part 12. It can also be understood that the first overturning part 11 comprises the first extension mechanism 111 and the turnplate 13, and the second overturning part 12 only comprises the second extension mechanism 121; or it can be understood that the first overturning part 11 only comprises the first extension mechanism 111, and the second overturning part 12 comprises the second extension mechanism 121 and the turnplate 13.

The bottom of the turnplate 13 is connected with the output gear 162 through the rotating shaft 163. Therefore, when the rotation is performed, the turnplate 13 rotates together. At this time, the first overturning part 11 and the second overturning part 12 realize simultaneous overturning.

The overturning driving device is connected with the turnplate 13 and drives the turnplate 13 to rotate. The turnplate 13 is used as a common part of the first overturning part 11 and the second overturning part 12, so that the turnplate 13 can drive the first overturning part 11 and the second overturning part 12 simultaneously. At the same time, the turnplate 13 can also be used to carry the battery pack 4.

As shown in FIG. 3 and FIG. 5, the first overturning part 11 and/or the second overturning part 12 in the embodiment are provided with an extension mechanism for taking out the battery pack 4 located on the electric vehicle 3 or the charging bin and place it in the first position or the third position of the overturning mechanism, or place the battery pack 4 located in the fourth position or the second position of the overturning mechanism on the electric vehicle 3 or the charging bin. The extension mechanism realizes the docking with the battery packs at different positions on the overturning mechanism with the electric vehicle 3 or the charging bin respectively, so as to realize the taking-and-placing or transferring of the battery pack 4.

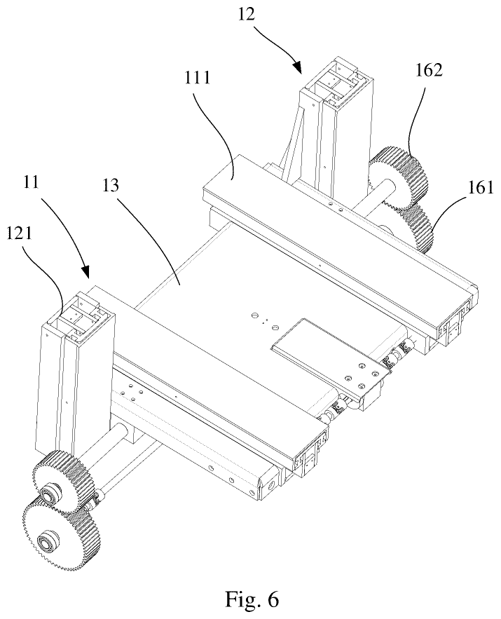

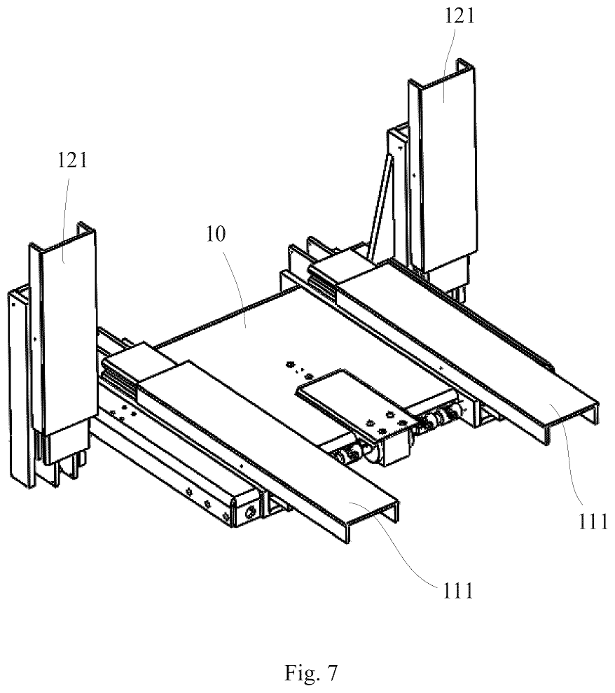

As shown in FIG. 6 and FIG. 7, the first overturning part 11 in the embodiment comprises a first extension mechanism 111, and the second overturning part 12 comprises a second extension mechanism 121. Wherein the first extension mechanism 111 is connected to the upper surface of the turnplate 13, and the second extension mechanism 121 is connected to both sides of the turnplate 13. The first extension mechanism 111 and the second extension mechanism 121 may extend as shown in FIG. 6. Wherein the first extension mechanism 111 takes and places the battery pack 4 at the first position or the fourth position, and the second extension mechanism 121 takes and places the battery pack 4 at the second position or the third position. Wherein, the first extension mechanism 111 docks with the electric vehicle 3 to realize the picking and placing of the battery pack 4. The second extension mechanism 121 docks with the charging bin to realize the taking and placing of the battery pack 4.

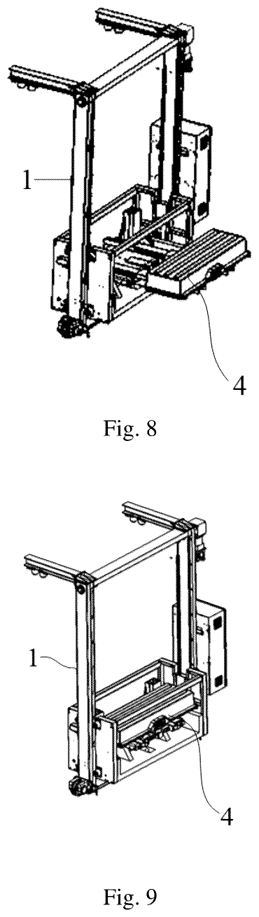

As shown in FIG. 3 and FIG. 5, when taking out the battery, after taking out the battery pack from the electric vehicle 3, the first extending mechanism 111 retracts and places the battery pack 4 at the first position of the first overturning part 11, as shown in FIG. 3 and FIG. 9, after driving the overturning mechanism to overturn 90 degrees in the first direction, the battery pack 4 is located at the second position of the second overturning part 12, and the second extension mechanism 121 extends to send the battery pack 4 at the second position to the corresponding charging bin, the second extension mechanism 121 retracts to the initial position. When swapping the battery, move the battery swapping device 1 to the charging bin with the fully charged battery pack 4, the second extension mechanism 121 extends to take out the fully charged battery pack 4 in the charging bin, as shown in FIG. 3 and FIG. 9, after retracting and placing the battery pack 4 in the third position of the second overturning part 12, after driving the overturning mechanism 10 to overturn 90 degrees in the second direction, as shown in FIG. 8, the battery pack 4 is located in the fourth position of the first overturning part 11, as shown in FIG. 7, the first extension mechanism 121 sends the battery pack 4 at the fourth position into the electric vehicle 3, and the first extension mechanism 121 retracts to the initial position.

The extension direction of the first extension mechanism 111 and the extension direction of the second extension mechanism 121 in the embodiment intersect, so that the battery pack 4 is relayed between the first extension mechanism 111 and the second extension mechanism 121. The battery pack 4 naturally contacts the second extension mechanism 121 after being transported to the end of the first extension mechanism 111. After overturning, the second extension mechanism 121 carries the battery pack 4 for transportation. On the contrary, the battery pack 4 naturally contacts the first extension mechanism 111 after being transported to the end of the second extension mechanism 121. After overturning, the first extension mechanism 111 carries the battery pack 4 for transportation.

In the embodiment, the first extension mechanism 111 and the second extension mechanism 121 are both telescopic forks. The telescopic fork can be any existing equipment that can realize the extension and retraction in the length direction. The first extension mechanism 111 and the second extension mechanism 121 in the embodiment are track structures that can be extended and driven internally by electromagnetic force, pulleys, sprockets or gears. Wherein, the transmission shaft 153 and the transmission shaft 156 are respectively connected with the internal structures of the first extension mechanism 111 and the second extension mechanism 121. During operation, the rotation generated by the transmission shaft 153 and the transmission shaft 156 becomes the extension and retraction motion of the first extension mechanism 111 and the second extension mechanism 121 through electromagnetic force, pulleys, sprockets or gears or other structures.

As shown in FIG. 3 and FIG. 5, the battery swapping device 1 in the embodiment also comprises a first transmission motor 151 and a second transmission motor 154 respectively, and both the first transmission motor 151 and the second transmission motor 154 are connected below the turnplate 13. Wherein, the first transmission motor 151 directly or indirectly drives the first extension mechanism 111, and the second transmission motor 154 directly or indirectly drives the second extension mechanism 121. Wherein, as shown in FIG. 4, the first transmission motor 151 connects the transmission shaft 153 through the reverser 152, so as to drive the first extension mechanism 111 to move. The second transmission motor 154 connects the transmission shaft 156 through the reverser 155, so as to drive the second extension mechanism 111 to move. Wherein, the interior of the reverser 152 and the reverser 155 can be bevel gears or other structures, the moving shafts of the first transmission motor 151 and the second transmission motor 154 are switched 90 degrees, and then drive the first extension mechanism 111 and the second extension mechanism 121 through the transmission shaft 153 and the transmission shaft 156.

In the embodiment, the battery swapping device 1 further comprises a limit sensor, and the limit sensor can be a limit switch or a distance sensor, etc. The limit sensor can be arranged on the non-moving portion of the first extension mechanism 111 to detect the moving distance or position of the moving part of the first extension mechanism, and the limit sensor can also be arranged on the turnplate 13 to detect the moving distance or position of the moving part of the first extension mechanism. The limit sensor is used to detect the extension distance of the first extension mechanism 111 and the second extension mechanism 121, and adjust the extension distance of the first extension mechanism 111 and the second extension mechanism 121 respectively through the first transmission motor 151 and the second transmission motor 154. For example, when the detected extension distance of the first extension mechanism 111 is less than the set distance, the first transmission motor 151 continues to rotate to reach the preset position, thereby realizing closed-loop control and ensuring the accurate in position of the first extension mechanism 111 and the second extension mechanism 121.

In the embodiment, the battery swapping device 1 also comprises an overturning in position sensor, which is used to detect the overturning angles of the first overturning part 11 and the second overturning part 12, and adjust the overturning part angles of the first overturning part 11 and the second overturning part 12 through the overturning motor 157. The overturning in position sensor can be a limit switch, an angle sensor, a grating ruler, etc. Wherein, the overturning in position sensor can be arranged on the base 14 to detect the overturning angle of the turnplate 13, so as to obtain the overturning angles of the first overturning part 11 and the second overturning part 12. For example, when the detected turnplate 13 is less than the set overturning angle, the overturning motor 157 continues to rotate to reach the preset position, thereby realizing closed-loop control and ensuring the accurate in position of the first overturning part 11 and the second overturning part 12.

As shown in FIG. 3 and FIG. 4, the overturning mechanism 10 in the embodiment comprises a base 14, and the turnplate 13 is rotationally connected to the base 14, therefore, the first overturning part 11 and the second overturning part 12 are rotationally connected to the base 14, the overturning driving device (the overturning motor 157 and the gear set 16) drives the first overturning part 11 and the second overturning part 12 to rotate. Wherein, the overturning motor 157 is connected to the turnplate 13, and the gear set is connected to the base 14.

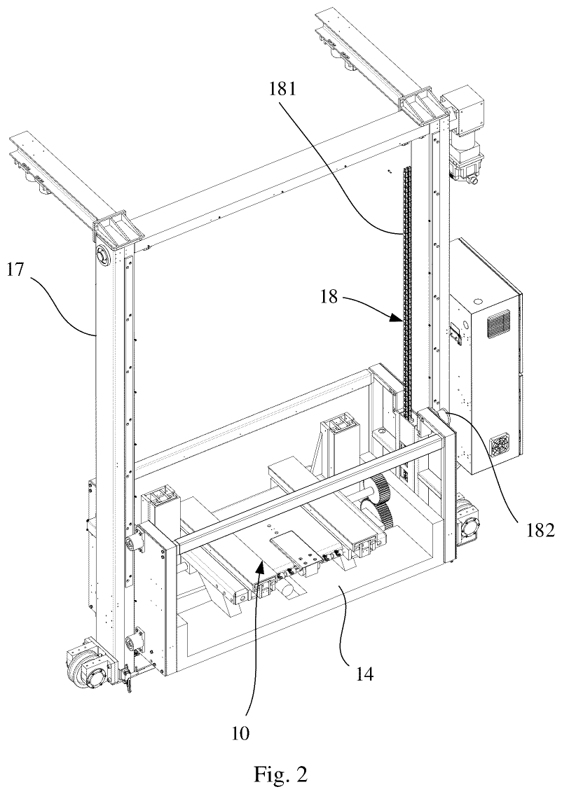

As shown in FIG. 2, the battery swapping device 1 in the embodiment comprises an external frame 17 and a lifting mechanism 18, the base 14 is connected to the external frame 17 through the lifting mechanism 18 and moves up and down relative to the external frame 17. The position adjustment of the battery pack 4 in the height direction can be realized through the lifting mechanism 18, so as to it can correspond to the charging bins of different heights. The external frame 17 itself can be provided with a horizontal moving mechanism to realize the movement of the battery swapping device 1 between the electric vehicle 3 and the charging device 2 by moving on the track or on the ground.

As shown in FIG. 2, the lifting mechanism 18 in the embodiment is connected to the external frame 17 through a chain transmission mechanism 181, and the lifting mechanism 18 and the external frame 17 are guided by a guide wheel 182. The chain transmission mechanism 181 plays a role in lifting the overturning mechanism 10, and the guide wheel 182 plays a smooth guiding role.

As shown in FIG. 3 and FIG. 4, the overturning mechanism 10 in the embodiment comprises the base 14, the first overturning part 11 and the second overturning part 12 are rotatably disposed relative to the base 14, wherein one end of the telescopic rod 157 is rotatably connected to the common bottom of the first overturning part 11 and the second overturning part 12 (i.e., the bottom of the turnplate 13), and the other end of the telescopic rod 157 is rotatably connected to the base 14. The turnplate 13 is connected with the rotation shaft 163, so that the turnplate 13 is limited to rotate on the axis of the rotation shaft 163. The telescopic rod 157 can be extended and retracted to change the distance between the two ends, that is, the distance between the turnplate 13 and the base 14. The telescopic force generated by the telescopic rod 157 generates a torque relative to the rotation shaft 163, thereby driving the rotation of the turnplate 13. Since the motion trails of all positions on the turnplate 13 are arcs, the connection between the telescopic rod 157 and the turnplate 13 moves in an arc with the turnplate 13, therefore, the two ends of the telescopic rod 157 are respectively connected rotatably, so that the telescopic rod 157 can adjust its tilt attitude to follow the rotation of the turnplate 13.

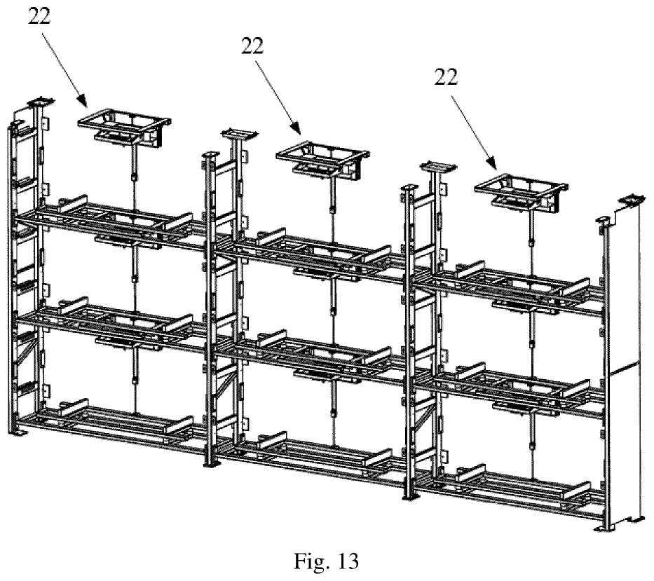

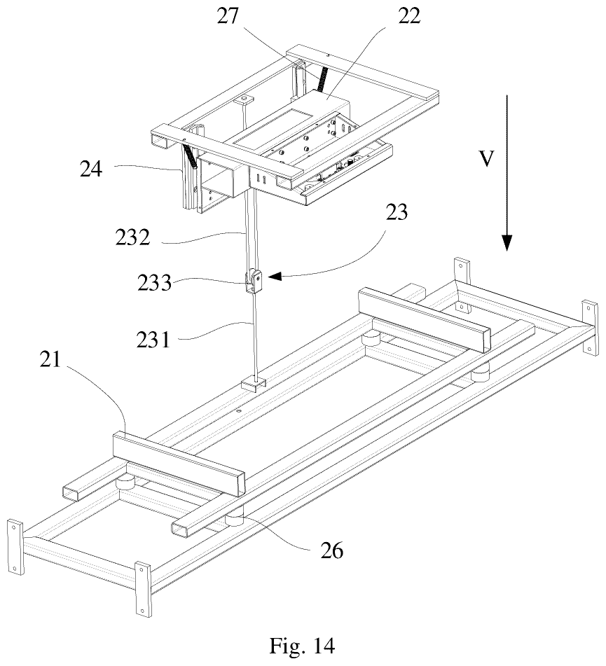

As shown in FIG. 12, FIG. 13 and FIG. 14, each charging bin A in the embodiment is also provided with a floating disc 21 and a linkage mechanism 23, the linkage mechanism 23 is respectively connected with the floating disc 21 and the electric connector 22, when the floating disc 21 generates a first displacement in a first floating direction V, the linkage mechanism 23 drives the electric connector 22 to move a second displacement in the direction close to the battery pack 4, so that the electric connector 22 can be electrically connected with the battery pack 4. In the embodiment, the floating disc 21 can be a flat plate structure, a frame structure or other structural members that can be used to support the battery pack and can float in the first direction, the charging assembly 2 further comprises a fixed disc 28, which is arranged below the floating disc 21 to support and carry the floating disc 21, the charging bin A is composed of a charging rack, the charging rack is composed of a plurality of transverse and longitudinal beams, the floating disc 21 can also be directly arranged on the charging rack.

As shown in FIG. 13 and FIG. 14, the charging device 20 in the embodiment further comprises an electric connector 22 for forming an electrical connection with the battery pack 4 to charge and discharge the battery pack 4. In the embodiment, the electric connector 22 is arranged above the floating disc 21 in the charging bin A, and can be electrically inserted with the battery pack 4 in the vertical direction to charge and discharge the battery pack, the electric connector 22 can be directly installed on the beam of the charging rack through the mounting seat, the electric connector 22 comprises a charging head 221 and a terminal (not shown in the figure, but actually can be located on the top or side of the electric connector 22), the charging head 221 is used to form an electrical connection with the charging port of the battery pack 4, and the terminal is used to connect an external charging module to charge the battery pack 4.

As shown in FIG. 14, the electric connector 22 in the embodiment docks with the battery pack 4 through linkage with the linkage mechanism 23, and is no longer a fixed electric connector 22, therefore, the moving electric connector 22 does not need to have the same transmission direction as the battery pack 4, and the orientation of the electric connector 22 can be any orientation. Wherein, the linkage mechanism 22 generates linkage through the change of the carrying of the floating disc 21, so that the electric connector 22 can respond in time and dock with the battery pack 4. The power for moving the electric connector 22 comes from the gravity of the battery pack 4, and no external drive is required, which is beneficial to simplify the internal structure of the charging device.

In the embodiment, the gravity of the battery pack 4 is used to move the floating disc 21, by arranging a linkage mechanism 23 between the floating disc 21 and the electric connector 22, the electric connector 22 is driven to move toward in the direction of the battery pack 4 to form an electrical connection, that is, the self-gravity of the battery pack 4 is used to realize the electrical connection, and no additional power is required to drive the electrical connector 22 to move, this linkage mode can be applied to the electrical connection of the battery pack 4 in multiple orientations.

As shown in FIG. 14, the first floating direction V is a vertical downward direction, the floating disc 21 carries the battery pack 4 in a vertical direction, and the floating disc 21 displaces toward the first floating direction V with the gravity of the battery pack 4. The first floating direction V is vertical downward, that is, the gravity of the battery pack 4 can be fully applied to the floating disc 21, so that the floating disc 21 can drive the linkage mechanism 23 more timely.

In the embodiment, the floating disc 21 can float in the vertical direction, specifically, the floating disc 21 is installed in the charging bin, in the embodiment, the floating disc 21 is installed on the fixed disc 28 and can move in the vertical direction under the gravity of the battery pack 4. It can be a spring, a rubber pad or other elastic members that can withstand the gravity compression of the battery pack and recover the deformation after withdrawing the battery pack 4. In other embodiments, the floating disc 21 can also be directly mounted on the transverse or longitudinal beam of the charging rack to achieve floating load.

As shown in FIG. 14, an electric connection seat of the battery pack 4 in the second position or the third position in the embodiment faces the electric connector 22 in the charging bin A. Preferably, an electric connection seat of the battery pack 4 in the first position or the fourth position faces the electric connector 22 in the electric vehicle 3.

In the embodiment, the overturning mechanism 10 is used to send the battery pack 4 at the second position into the floating disc 21, and drive the electric connector 22 to connect with the battery pack 4 through the linkage mechanism 23; the overturning mechanism 10 moves the battery pack 4 out of the floating disc 21 from the third position, and drives the electric connector 22 to separate from the battery pack 4 through the linkage mechanism 23.

As shown in FIG. 3, the second displacement direction in the embodiment is vertical downward, the electric connector 22 is arranged above the floating disc 21, and the linkage mechanism 23 is arranged between the electric connector 22 and the floating disc 21 to drive the electric connector 21 to move up and down in the vertical direction. In the embodiment, when the battery pack 4 enters the charging bin A, the charging port faces upward, in order to achieve the electrical connection, the electric connector arranged with the charging head 221 facing downward is moved downward in the vertical direction through the linkage mechanism, that is, the second displacement direction is the vertical downward direction to achieve electrical connection between the electric connector and the battery pack. When the battery pack 4 is installed on the electric vehicle, the battery pack 4 and the electrical connector 22 on the electric vehicle generally complete the electrical connection in the horizontal direction, the horizontal electrical connection is suitable for the electric vehicle during driving, especially in the case of severe shaking of the vehicle, so as to provide a reliable and stable electrical connection, when the battery pack 4 on the electric vehicle is unloaded and charged and discharged, the battery pack needs to be rotated 180 degrees horizontally to dock with the electric connector in the charging bin, for the battery pack with a large size, it needs to occupy a large space for battery swapping, which is not suitable for the case of a small area for battery swapping, in the embodiment, the electric connector 22 arranged above the floating disk is used, and charging and discharging can be achieved by simply overturning the battery pack 4 90 degrees in the vertical direction, without occupying a large space for battery swapping, at the same time, the gravity of the battery pack 4 is used to realize the electrical connection between the battery pack 4 and the electric connector 22, which eliminates the need for additional drive mechanisms, the electrical connection between the battery pack and the electric connector 22 can be realized by placing the battery pack in the place on the floating disc, which saves the complex operation of aligning the electrical connector and the battery pack, the charging connection efficiency is higher and the charging cost is lower.

In other embodiments, the electrical connector 22 can also be adaptively arranged on the side or bottom of the charging bin to adapt to the different orientations of the socket ends of the battery pack 4 placed in the charging bin A. Specifically, the linkage mechanism 23 in the embodiment can be used, it is only necessary to adjust the setting position of the electric connector 22 and make the electric connector 22 move in the direction towards the battery under the gravity of the battery pack 4.

In the embodiment, during the process of the battery pack 4 entering the charging bin, the bottom of the battery pack is higher than the surface of the floating disc, therefore, the distance between the electric connector 22 and the surface of the floating disc 21 must be greater than the height of the battery pack 4 to avoid interference; therefore, after the battery pack 4 is placed on the floating disc 21, the moving distance of the electric connector 22 must be greater than the moving distance of the floating disc to realize the electrical connection between the electric connector 22 and the battery pack 4.

As shown in FIG. 14, the floating disc 21 in the embodiment is connected with a floating reset element 26, the floating reset element 26 is used to drive the floating disc 21 to reset in the second floating direction when there is no gravity effect of the battery pack 4, the second floating direction is opposite to the first floating direction V. After the battery pack 4 is removed, the floating reset element 26 provides an active restoring force to make the floating disc 21 return to its original position in preparation for the subsequent charging of the battery pack 4.

As shown in FIG. 14, the floating reset element 26 in the embodiment is an elastic element, when the floating disc 21 carries the battery pack 4, the elastic element deforms in the first floating direction V and generates an elastic recovery force toward the second floating direction. The floating reset element 26 in the embodiment can be the same element as the aforementioned elastic element, or can be set as different elements. By setting the floating reset element 26, in the process of taking out the battery pack 4 from the floating disc 21, the floating reset element 26 acts on the floating disc 21 to move up and reset in the vertical direction, thereby driving the electric connector 22 to separate from the battery pack 4, no additional driving mechanism is required to drive the electric connector to separate from the battery pack, at the same time, the electrical connection can be separated during the process of taking out the battery pack, which improves the efficiency of taking out the battery pack, thus, the whole power exchange efficiency is improved. Specifically, the floating reset element 26 can be an element that can undergo elastic deformation under the action of an external force and recover the deformation after the external force is removed, such as a spring, both ends of the floating reset element are respectively connected with the floating disc 21 and the fixed disc 28, or both ends of the floating reset element 26 are respectively connected with the floating disc and the transverse or longitudinal beam on the charging rack.

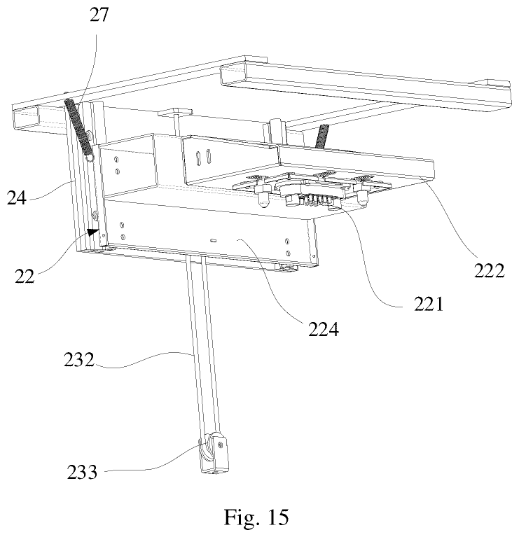

As shown in FIG. 14 and FIG. 15, the electric connector 22 in the embodiment is connected with a charging reset element 27, the charging reset element 27 is used to drive the electric connector 22 to reset when there is no gravity of the battery pack 4. The charging reset element 27 can be set between the electric connector 22 and the mounting seat 24, or between the electric connector 22 and the transverse or longitudinal beam on the charging rack, by setting the charging reset element 27, during the process of taking out the battery pack, since the floating disc 21 no longer exerts a downward force on the electric connector 22, the electric connector 22 moves up to the original position under the action of the charging reset element 27, so that the battery pack 4 can be put in subsequently. Specifically, the charging reset element 27 can be a spring or other elements that can undergo elastic deformation under the action of an external force and recover the deformation after the external force is removed.

As shown in FIG. 14 and FIG. 15, the floating reset element 26 and the charging reset element 27 in the embodiment can be set at the same time, so that the electric connector 22 and the floating disc 21 can be reset regardless of the linkage mechanism 23. In the case of some linkage mechanisms 23, such as connecting rods, only one of the floating reset element 26 and the charging reset element 27 needs to be set, and any one of the electrical connector 22 and the floating disc 21 will drive the other to reset.

As shown in FIG. 14 and FIG. 15, the charging reset element 27 in the embodiment is an elastic element, when the floating disc 21 carries the battery pack 4, the elastic element deforms in the direction of the second displacement and generates an elastic deformation force in the direction opposite to the second displacement.

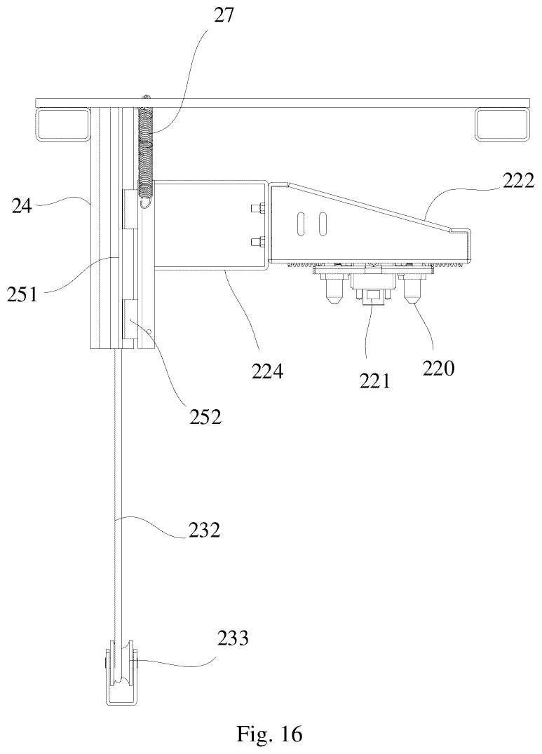

As shown in FIG. 16, the charging device 2 in the embodiment further comprises a guiding mechanism, the guiding mechanism is used to guide the electric connector 22 to move towards the battery pack 4 under the action of the linkage mechanism 23 to realize electrical connection. The guiding mechanism can guide the moving direction of the electric connector 22.

As shown in FIG. 16, the guiding mechanism in the embodiment comprises a slider 252 and a guide rail 251, wherein, the slider 252 or the guide rail 251 is fixed on the electric connector 22, and is slidably connected with the relatively fixed guide rail 251 or the slider 252.

As shown in FIG. 14 and FIG. 16, the electric connector 22 in the embodiment comprises a connection seat 222 and a charging head 221, the charging head 221 is arranged on the connection seat 222, wherein, the connection seat 222 is connected with the linkage mechanism 23, and the charging head 221 is used to connect with the electric connection seat of the battery pack 4.

As shown in FIG. 14 and FIG. 16, a floating element 223 is arranged between the connection seat 222 and the charging head 221 in the embodiment to realize the floating electrical connection between the electric connector 22 and the battery pack 4. The floating element 223 realizes the floating displacement of the charging head 221. Therefore, in the process of docking with the electric connection seat of the battery pack 4, even if there is an error, the error can be corrected by the floating displacement of the charging head 221.

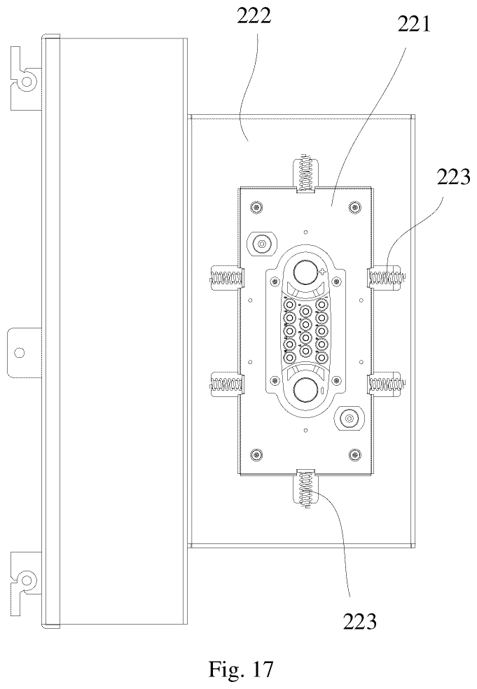

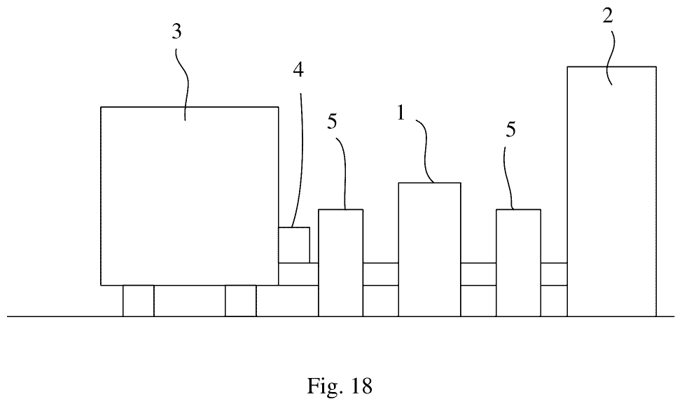

As shown in FIG. 16 and FIG. 17, the floating element 223 in the embodiment is an elastic element, and the connection seat 222 is provided with an accommodating cavity for accommodating the charging head 221, and the charging head 221 is arranged in the accommodating cavity through the elastic element. As shown in FIG. 16 and FIG. 17, the charging head 221 in the embodiment is further provided with a positioning pin 220, and the positioning pin 220 is used for docking with the positioning hole arranged on the battery pack 4.

As shown in FIG. 15 and FIG. 16, the charging device 2 in the embodiment further comprises a slider 252 and a guide rail 251, the electric connector 22 further comprises a base 224, the slider 252 or the guide rail 251 is fixed on the base 224, and is slidably connected with the corresponding provided the guide rail 251 or the slider 252, the connection seat 222 extends toward the direction away from the slider 252 and the guide rail 251.

As shown in FIG. 14, the linkage mechanism 23 in the embodiment comprises a sliding mechanism 233, a first traction member 231, and a second traction member 232, the first traction member 231 is connected with the sliding mechanism 233 and the floating disc 21 respectively, the second traction member 232 is connected with the electric connector 22 and the mounting seat 24 respectively, the electric connector 22 is installed on the mounting seat 24 and moves relative to the mounting seat 24, and the second traction member 232 is slidably connected with the sliding mechanism 233. This constitutes the structure of the movable pulley.

The first traction member 231 and the second traction member 232 may be steel wire ropes, belts and other structures. The sliding mechanism 233 may be a structure such as a pulley or a slider. The second traction member 232 slides under the sliding mechanism 233, wherein the second traction member 232 not only slides relative to the sliding mechanism 233, but also moves up and down with the sliding mechanism 233. The first traction member 231 is directly fixed on the sliding mechanism 233, so it moves together with the sliding mechanism 233. Wherein, regardless of the direction of movement, the moving distance of the second traction member 232 includes the sliding distance relative to the sliding mechanism 233 and the distance moving with the sliding mechanism 233, while the first traction member 231 only includes the distance moving with the sliding mechanism 233, so the moving distance of the second traction member 232 is twice that of the first traction member 231. At the same time, one end of the second traction member 232 is connected to the mounting seat 24 and remains fixed, therefore, the electric connector 22 connected to the other end of the second traction member 232 realizes twice the travel distance relative to the first traction member 231, thereby realizing that the second displacement is greater than the first displacement.

In the embodiment, the battery swapping station has a battery swapping lane for the moving of the electric vehicle 3, one side or both sides of the battery swapping lane are provided with a charging device 2, and the battery swapping device 2 performs reciprocating motion between the charging device 2 and the electric vehicle 3.

### Embodiment 2

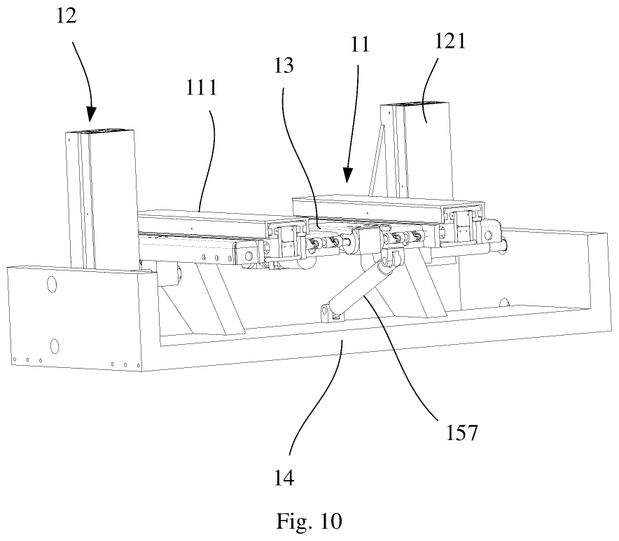

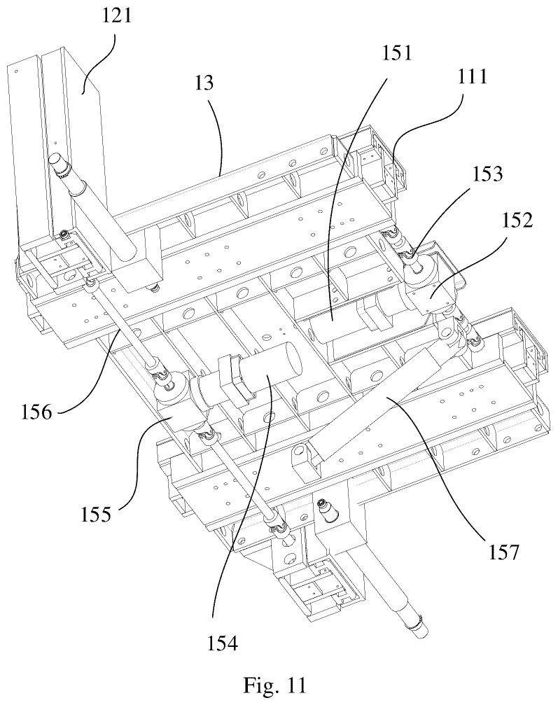

As shown in FIG. 10 and FIG. 11, the difference between this embodiment and the embodiment 1 is that in this embodiment, the overturning driving device is driven by the telescopic rod 157. Therefore, the overturning motor is not comprised in this embodiment. Wherein, as shown in FIG. 10 and FIG. 11, the telescopic rod 157 of this embodiment is connected with the first overturning part 11 and/or the second overturning part 12 and drives the first overturning part 11 and the second overturning part 12 to rotate. The telescopic rod 157 generates the movement of the first overturning part 11 and the second overturning part 12 through its own length direction. The telescopic rod 157 may be a pneumatic or hydraulic mechanism.

A plurality of telescopic rods 157 can be provided, which are respectively connected with the first overturning part 11 and the second overturning part 12. It also can be arranged to connect with the first overturning part 11 and the second overturning part 12 simultaneously. Wherein, in this embodiment, since the bottom of the first overturning part 11 and the second overturning part 12 are both connected to the base 14, the telescopic rod 157 can be connected to the base 14 simultaneously.

As shown in FIG. 10 and FIG. 11, the overturning mechanism 10 in this embodiment comprises a base 14, the first overturning part 11 and the second overturning part 12 are rotatably arranged relative to the base 14, wherein one end of the telescopic rod 157 is rotatably connected to the common bottom of the first overturning part 11 and the second overturning part 12 (i.e., the bottom of the turnplate 13), and the other end of the telescopic rod 157 is rotatably connected to the base 14. The movement in the length direction of the telescopic rod 157 itself and the rotation of both ends can realize the combination of movements, which can avoid jamming during the operation and smoothly realize the overturning of the first overturning part 11 and the second overturning part 12.

The other parts in this embodiment adopt the same mechanisms as that in embodiment 1, and it can also adopt other alternative means that can be adopted in the embodiment 1, so they will not be repeated here.

### Embodiment 3

As shown in FIG. 12, the difference between the battery swapping station in this embodiment and the battery swapping station in the embodiment 1 is that the battery swapping device 1 in this embodiment itself may not have an extension mechanism, but only have a structure related to the overturning function (comprising the overturning mechanism 10), so the battery is taken and placed through an external separate battery taking-and-placing mechanism 5. In this embodiment, the battery taking-and-placing mechanism 5 can be the same one or multiple.

Specifically, the battery swapping device 1 may not have the first extension mechanism 111 and the second extension mechanism 121 in the embodiment 1, at this time, as shown in FIG. 12, the battery pack 4 is taken from the charging bin of the charging device 2 or the electric vehicle 3 and placed on the overturning mechanism through a separate battery taking-and-placing mechanism 5, and the battery pack 4 is taken from the overturning mechanism and loaded into the charging bin of the charging device 2 or the electric vehicle 3. The battery taking-and-placing mechanism 5 may be a telescopic mechanism, a battery clamping mechanism or other mechanisms capable of taking and placing batteries from the charging bin or the electric vehicle.

Alternatively, the battery swapping device 1 may not have any one of the first extension mechanism 111 and the second extension mechanism 121 in the embodiment 1, at this time, the battery pack 4 is taken from the charging bin of the charging device 2 or the electric vehicle 3 and placed on the overturning mechanism through a separate battery taking-and-placing mechanism 5, or the battery pack 4 is taken from the overturning mechanism and loaded into the charging bin of the charging device 2 or the electric vehicle 3.

The battery swapping device of the battery swapping station of the invention can be significantly reduced in structure relative to the battery swapping device that rotates in a plane. By means of the present invention, taking and placing of a large battery pack in a charging station within a small space and structure can be completed. The charging device may match with battery packs with different orientations. Therefore, battery swapping for an electric vehicle using a single large battery pack can be realized within a battery swapping station with a small occupied area, such that the cost of a battery pack is reduced, and popularization is facilitated. Although the specific embodiments of the present invention are described above, it should be understood by those skilled in the art that this is only an example, and the scope of protection of the present invention is defined by the appended claims. Those skilled in the art can make various changes or modifications to these embodiments without departing from the principles and essence of the present invention, but these changes and modifications fall into the scope of protection of the present invention.

1. A battery swapping station, which is characterized in that, the battery swapping station comprises:
a vehicle carrying platform, for parking an electric vehicle so as to swap battery packs;
a charging device, which is provided with a plurality of charging bins for having battery packs placed therein, wherein electric connectors are arranged in the charging bins for being electrically connected to the battery packs located in the charging bins, so as to carry out charging;
and a battery swapping device, for taking, placing and transferring batteries between the electric vehicle and the charging bin, the battery swapping device being provided with an overturning mechanism for vertically overturning a battery pack taken out from the charging bin or the electric vehicle.

2. The battery swapping station as claimed in claim 1, which is characterized in that the overturning mechanism is used to overturn a discharged battery pack taken out from the electric vehicle from a first position to a second position in a first direction; the overturning mechanism is also used to overturn a fully charged battery pack taken out from the charging bin from a third position to a fourth position in a second direction, wherein the first direction is opposite to the second direction.

3. The battery swapping station as claimed in claim 2, which is characterized in that the overturning mechanism comprises a first overturning part and a second overturning part, the first overturning part is used to carry the battery pack at the first position or the fourth position, the second overturning part is used to carry the battery pack at the second position or the third position, and the first overturning part and the second overturning part are overturned coaxially.

4. The battery swapping station as claimed in claim 2, which is characterized in that the battery pack has a first side and a second side which are perpendicular to each other, when the battery pack is located at the first position or the fourth position, the first side is carried on the first overturning part, and the second side is abutted against the second overturning part; when the battery pack is located at the second position or the third position, the second side is carried on the second overturning part, and the first side is abutted against the first overturning part.

5. The battery swapping station as claimed in claim 3, which is characterized in that the first overturning part and the second overturning part are arranged vertically to each other.

6. The battery swapping station as claimed in claim 3, which is characterized in that the first overturning part and the second overturning part are driven by the same overturning driving device, or the first overturning part and the second overturning part are driven by different overturning driving devices.

7. The battery swapping station as claimed in claim 6, which is characterized in that the overturning driving device comprises a telescopic rod which is connected with the first overturning part and/or the second overturning part and drives the first overturning part and the second overturning part to rotate.

8. The battery swapping station as claimed in claim 6, which is characterized in that the overturning driving device comprises an overturning motor and a gear set, the overturning motor drives the gear set to rotate, the gear set is connected with the first overturning part and/or the second overturning part and drives the first overturning part and/or the second overturning part to rotate.

9. The battery swapping station as claimed in claim 2, which is characterized in that each of charging bins is further provided with a floating disc and a linkage mechanism, and the linkage mechanism is respectively connected with the floating disc and the electric connector, when the floating disc generates a first displacement in a first floating direction, the linkage mechanism drives the electric connector to move a second displacement in the direction close to the battery pack, so that the electric connector can be electrically connected with the battery pack.

10. The battery swapping station as claimed in claim 9, which is characterized in that the first floating direction is a vertical downward direction, the floating disc carries the battery pack in a vertical direction, and the floating disc displaces toward the first floating direction with the gravity of the battery pack.

11. The battery swapping station as claimed in claim 9, which is characterized in that an electric connection seat of the battery pack in the second position or the third position faces the electric connector in the charging bin;
or, an electric connection seat of the battery pack in the first position or the fourth position faces the electric connector in the electric vehicle.

12. The battery swapping station as claimed in claim 9, which is characterized in that the overturning mechanism is used to send the battery pack at the second position into the floating disc, and drive the electric connector to connect with the battery pack through the linkage mechanism; the overturning mechanism moves the battery pack out of the floating disc from the third position, and drives the electric connector to separate from the battery pack through the linkage mechanism.

13. The battery swapping station as claimed in claim 9, which is characterized in that the linkage mechanism comprises a sliding mechanism, a first traction member and a second traction member, the first traction member is connected with the sliding mechanism and the floating disc respectively, the second traction member is connected with the electric connector and a mounting seat respectively, the electric connector is installed on the mounting seat and moves relative to the mounting seat, and the second traction member is slidably connected with the sliding mechanism.

14. The battery swapping station as claimed in claim 9, which is characterized in that the overturning mechanism comprises a first overturning part and a second overturning part, the first overturning part is used to carry the battery pack in the first position taken out of the electric vehicle or to send the battery pack in the fourth position to the electric vehicle, the second overturning part is used to send the battery pack in the second position to the floating disc, or to carry the battery pack in the third position taken out from the floating disc.

15. The battery swapping station as claimed in claim 6, which is characterized in that the battery swapping device comprises a lifting mechanism and an external frame, the overturning driving device is connected to the lifting mechanism and drives the overturning mechanism to rotatably connect relative to the lifting mechanism, the lifting mechanism is connected to the external frame and moves up and down relative to the external frame so as to dock with the charging bins of different heights.

16. The battery swapping station as claimed in claim 3, which is characterized in that the first overturning part comprises a first extension mechanism, and the second overturning part comprises a second extension mechanism, wherein the first extension mechanism is used to take out the battery pack from the electric vehicle and place it at the first position of the first overturning part, or to send the battery pack at the fourth position to the electric vehicle, the second extension mechanism is used to send the battery pack at the second position into the charging bin or take the battery pack out of the charging bin and place it at the third position of the second overturning part;
preferably, a transmission route of the first extension mechanism and a transmission route of the second extension mechanism intersect, so that the battery pack is relayed between the first extension mechanism and the second extension mechanism;
preferably, at the first position and the fourth position, the first overturning part is horizontally arranged and docks with the electric vehicle; at the second position and the third position, the second overturning part is horizontally arranged and docks with the charging bin.

17. The battery swapping station as claimed in claim 3, which is characterized in that the first overturning part and the second overturning part are both connected to a turnplate, the turnplate drives the first overturning part and the second overturning part to rotate together, wherein the second position and the third position are the same position, and the first position and the fourth position are the same position.

18. The battery swapping station as claimed in claim 9, which is characterized in that the overturning mechanism comprises a first overturning part and a second overturning part, the first floating direction is a vertical downward direction, the second overturning part moves the battery pack into the floating disk in a horizontal position, the floating disk carries and receives the battery pack in a vertical direction, and the floating disk moves toward the first floating direction with the gravity of the battery pack.

19. The battery swapping station as claimed in claim 9, which is characterized in that the electric connector is connected with a charging reset element, and after the battery pack is moved out from the floating disc by the overturning mechanism, the charging reset element drives the electric connector to reset.

20. The battery swapping station as claimed in claim 1, which is characterized in that the battery swapping station has a battery swapping lane for the moving of the electric vehicle, one side or both sides of the battery swapping lane are provided with a charging device, and the battery swapping device performs reciprocating motion between the charging device and the electric vehicle.
